(19) United States
(12) Patent Application Publication
(10) Pub. No.: US 2020/0349577 A1
(43) Pub. Date: Nov. 5, 2020

(54) SYSTEM AND METHOD TO ACCESS A CHANNEL ON OCCURRENCE OF A FINANCIAL TRANSACTION FRAUD

(71) Applicant: Ominaya Technologies Private Limited, Mysore (IN)

(72) Inventor: Fnu Pranesh, BANGALORE (IN)

(21) Appl. No.: 16/563,166

(22) Filed: Sep. 6, 2019

(30) Foreign Application Priority Data
Mar. 15, 2019 (IN) 201941010103

(51) Int. Cl. G06Q 20/40; G06Q 20/10

(52) U.S. Cl. CPC G06Q 20/4016; G06Q 20/1085

(57) ABSTRACT

A system to access a channel on occurrence of a financial transaction fraud is disclosed. The processing subsystem includes a registration module, configured to register a user of a financial transaction system for accessing an allocated access channel. The processing subsystem also includes a retrieving module, configured to retrieve a plurality of criterion from the registered user to enable the allocated access channel. The processing subsystem also includes a transaction module, configured to validate authorization and authentication of the registered user and transaction request with respect to the allocated access channel. The processing subsystem also includes a processing module, configured to initialise and modify a default state of the allocated access channel based on the validation of the plurality of criterion from the registered user. The processing subsystem also includes a. notification module, configured to notify the registered user about the modified state of the allocated access channel,

This Application claims priority from a complete patent application filed in India having Patent Application No. 201941010103, tiled on Mar. 15, 2019 and titled “SYSTEM AND METHOD TO ACCESS A CHANNEL ON OCCURRENCE OF A FINANCIAL TRANSACTION FRAUD”.

### FIELD OF INVENTION

Embodiments of a present disclosure relates to Banking, Financial Services and insurance (REST) transaction systems, and more particularly to a system and method to access a channel on occurrence of a Banking. Financial Services and Insurance (BFSI) transaction fraud.

### BACKGROUND

Banking, Financial Services and Insurance (BFSI) sector has always been considered to be one of the most vibrant industry verticals for the economy and expected to be able to function most securely, given the fact that it is related to money with an equally challenging ecosystem. The BFSI systems enable user registration, deposit, withdraw, transfer, pay, purchase and enquiry services to states and people, households and businesses. BFSI institutions have played an integral and leading role in planning and implementing financial policy of the government and country. In recent years BFSI services are offered to customers through various channels that are teller assisted, mobile, interact, cards, messaging, interactive voice response, automated teller machines, point of sale equipment, kiosk terminal, agent assisted of both physical human driven and technology driven access mechanisms. The technology driven BFSI channels are secured by customer identification, authentication, authorization and notification steps.

Due to unethical usage and incorrect implementation of systems/processes the technology driven “Access” channels are compromised by fraudulent users, resulting in a high rate of frauds in the Banking, financial services and insurance (BFSI) segment, Some examples of fraudulent transactions through technology driven banking channels are Card duplication, Skimming, Social Engineering (pretending be bank executive to get authentication information like Personal Identification Number (PIN), passwords, Card number, Mobile money access details, Internet banking credentials), Access attempts (guessing internet login and passwords). User channel theft, Banking service provider data breaches. In case of fraudulent transaction, liability and accountability will be transferred mainly to one of two stake holders i.e. Customer and Issuer financial institute (who offer “access” channel to their customers).

In one approach, the registration request from a user is for accessing plurality of access channels after financial transaction fraud is disclosed. Only a few predetermined criterions are taken into consideration. Here, the process discloses transaction time and transaction volume as one of the user-defined criterion. More efficient approach would be to taken into consideration on all important factors. State of the value store (account, wallet, locker), Transaction amount, Transaction velocity, Permitted location, Channel control, Type of transaction, and combination thereof are important factors that enable in making the financial transaction more secure from Fraud.

Hence, there is a need for an improved secured system and a process change at an organisation level to have an “access” channel on occurrence of a financial transaction fraud and a method to operate the same and therefore address the aforementioned issues.

### BRIEF DESCRIPTION

In accordance with one embodiment of the disclosure, a system to access a channel on occurrence of a financial transaction fraud is provided. The system includes a processing subsystem. The processing subsystem includes a registration module. The registration module is configured to register a user of a banking system for accessing an allocated access channel. The processing subsystem also includes a retrieving module. The retrieving module is operatively coupled to the registration module. The retrieving module is configured to retrieve a plurality of criterion from the registered user to enable the allocated access channel. The processing subsystem also includes a transaction module. The transaction module is operatively coupled to the retrieving module. The transaction module is configured to validate authorization and authentication of the registered user and transaction request with respect to the allocated access channel.

The processing subsystem also includes a processing module. The processing module is operatively coupled to the transaction module. The processing module is configured to initialize to default state and modify a default state of the allocated access channel based on the validation of the plurality of criterion from the registered user. The processing subsystem also includes a notification module. The notification module is operatively coupled to the processing module. The notification module is configured to notify the registered user about the modified state of the allocated access channel. The system also includes a memory subsystem. The memory subsystem is operatively coupled to processing subsystem. The memory subsystem is configured to store the plurality of criterion from the user corresponding to the allocated access channel.

In accordance with one embodiment of the disclosure, a method for accessing a channel on occurrence of a financial transaction fraud is provided. The method includes registering a user of a financial transaction system for accessing an allocated access channel. The method also includes retrieving a plurality of criterion from the registered user to enable the allocated access channel. The method also includes validating the registered user and a transaction request with respect to the allocated access channel. The method also includes initialization to default state and modifying a default state of the allocated access channel based on the validation of the plurality of criterion from the registered user. The method also includes modifing a default state of the allocated access channel based on the validation of the plurality of criterion from the registered user. The method also includes notifying the registered user about the modified state of the allocated access channel.

To further clarify the advantages and features of the present disclosure, a. more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to access a bank channel on occurrence of a BFSI transaction fraud in accordance with an embodiment of the present disclosure;

FIG. 2 is a schematic representation of an embodiment representing the system to access the channel on occurrence of the BFSI transaction fraud of FIG. 1 in accordance of an embodiment of the present disclosure;

FIG. 3 is a schematic representation of an embodiment representing the system to access the access channel on occurrence of the BFSI transaction fraud of FIG. 1 in accordance of an embodiment of the present disclosure. This schematic representation is for mobile application as an example, however disclosure applicable to web/internet access, messaging, interactive voice response, automated teller machine, external interactable interface specification in the form of software/network/system based application programming interface (API), teller machines, point of sales terminal, kiosk systems, customer access devices and equipment/mechanism which provide user an access channel;

FIG. 4 is a block diagram of a computer or a server in accordance with an embodiment of the present disclosure; and

FIG. 5 is a flowchart representing the steps of a method for accessing a channel on occurrence of a BFSI transaction fraud in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system to access a user channel on occurrence of a financial transaction fraud. The system includes a processing subsystem. The processing subsystem includes a registration module. The registration module is configured to register a user of a financial system for accessing an allocated access channel. The processing subsystem also includes a retrieving module. The retrieving module is operatively coupled to the registration module. The retrieving module is configured to retrieve a plurality of criterion from the registered user to enable the allocated access channel. The processing subsystem also includes a transaction module. The transaction module is operatively coupled to the retrieving module. The transaction module is configured to validate authorization and authentication of the registered user and transaction request with respect to the allocated access channel.

The processing subsystem also includes a processing module. The processing module is operatively coupled to the transaction module. The processing module is configured to modify a default state of the allocated access channel based on the validation of the plurality of criterion from the registered user. The processing subsystem also includes a notification module. The notification module is operatively coupled to the processing module. The notification module is configured to notify the registered user about the modified state of the allocated access channel. The system also includes a memory subsystem. The memory subsystem is operatively coupled to processing subsystem. The memory subsystem is configured to store the plurality of criterion from the user corresponding to the allocated access channel.

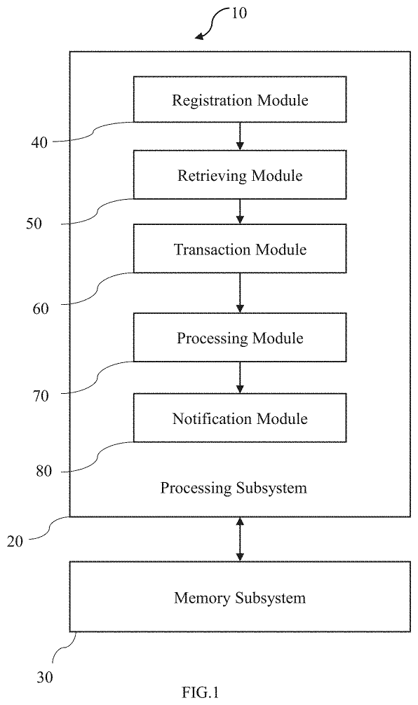

FIG. 1 is a block diagram representation of a system to access a user channel on occurrence of a financial transaction fraud 10 in accordance with an embodiment of the present disclosure. As used herein, the term “financial transaction fraud” are categorized as lost, stolen, not received, issued on a fraudulent application, counterfeit, fraudulent processing of transactions, account takeover or other fraudulent conditions as defined by the financial institution or the member company. As used herein, the term “access channel” is defined as a gateway for financial transaction.

The system 10 includes a processing subsystem 20. The processing subsystem 20 includes a registration module 40. The registration module 40 is configured to register a user of a financial system for accessing an allocated access channel. In one embodiment, the user referred here is the user of a particular financial institution. In another embodiment, the allocated access channel comprises of at least one of a credit card, a debit card, pre-paid card, gift card, virtual card, gift coupon based transaction, tokenization of the transaction, an Automated Teller Machine (ATM) card, an internet transactions, messaging based transactions, interactive voice response transaction, point of sale based transaction, application programming interfaced based transaction and a mobile transaction.

As used herein the term “financial institution” refers to institution who offers financial services, Banks, insurance, mobile money/wallet, eco system partner of financial service providers, financial services aggregators, technology and solution providers.

As used herein the term “financial transaction” or “BFSI transaction” refers financial institutions offered services of customer registration, deposit, withdrawal, transfer, payment, purchase and enquiry (balance, history, status etc.)

As used herein, the term “card” refers to a small plastic card, electronic card or virtual card issued by a financial institutions, allowing the holder to perform financial transactions. As used herein, an “automated teller machine (ATM)” is an electronic outlet that allows customers to complete financial transactions without the aid of a financial transaction branch representative or teller. As used herein, the “internet banking” refers to a method of financial transactions in which transactions are conducted electronically via the Internet. As used herein, the “mobile banking” refers to the use of a smartphone or other cellular device to perform financial transactions. As used herein, the term “Point Of Sale (POS)” is a terminal electronic system used to carryout financial transactions by a customer at retail counter/premises. As used herein, the term “SMS banking” refers to a method of carryout financial transactions using mobile or other cellular devices using messaging exchanges. As used herein, the term “Interactive Voice Response (IVR) ” refers to a method of carryout financial transactions using telephone, mobile or other cellular devices using voice and/or dial pad signal exchanges.

The processing subsystem 20 also includes a retrieving module 50. The retrieving module 50 is operatively coupled to the registration module 40. The retrieving module 50 is configured to retrieve a plurality of criterion from the registered user to enable the allocated access channel. In one embodiment, the plurality of criterion comprises of at least one of channel state, transaction amount, transaction volume, transaction velocity, permitted location, channel control, transaction type and transaction time.

A used herein, the term “transaction” is an agreement between a buyer (or source) and a seller (or beneficiary) to exchange of value, goods, services or financial instruments, here specifically the agreement is between a customer and a bank. As used herein, the term “criterion” refers to a standard by which something may be judged or decided.

The processing subsystem 20 also includes a transaction module 60. The transaction module 60 is operatively coupled to the retrieving module 50. The transaction module 60 is configured to validate authorization and authentication of the registered user and transaction request with respect to the allocated access channel. In one embodiment, the authorization is enabled by after validating every mentioned criterion.

The processing subsystem 20 also includes a processing module 70. The processing module 70 is operatively coupled to the transaction module 60. The processing module 70 is configured to initialize a default state of the allocated access channel based on the validation of the plurality of criterion from the registered user. The processing module 70 is configured to modify a default state of the allocated access channel based on the validation of the plurality of criterion from the registered user. In one embodiment, the modification of the default state comprises of a first state or a second state. In another embodiment, after authentication of the registered user the first state of “locked” (Off/Disabled/Closed)” is changed to the second state of “unlocked (On/Enabled/Open)”. In such embodiment, the state representation could be in any of the name or form to represent two mutually exclusive states.

The processing subsystem 20 also includes a notification module 80. The notification module 80 is operatively coupled to the processing module 70. The notification module 80 is configured to notify the registered user about the modified state of the allocated access channel. In one embodiment, the notification is simultaneously provided to the registered user bank. In another embodiment, the notification is enabled in real time through a pre-determined communication channel. In such embodiment, the pre-determined communication channel comprises at least one of text message, email, call, push-notification, user interface to display notification, alerts, sound and the like.

The system 10 also includes a memory subsystem 30. The memory subsystem 30 is operatively coupled to processing subsystem 20. The memory subsystem 30 is configured to store the plurality of criterion from the user corresponding to the allocated access channel. In one embodiment, storing may be enabled in remote storage or local storage.

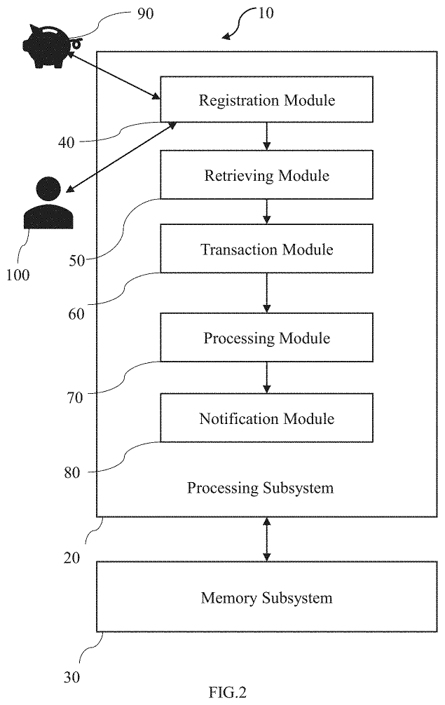

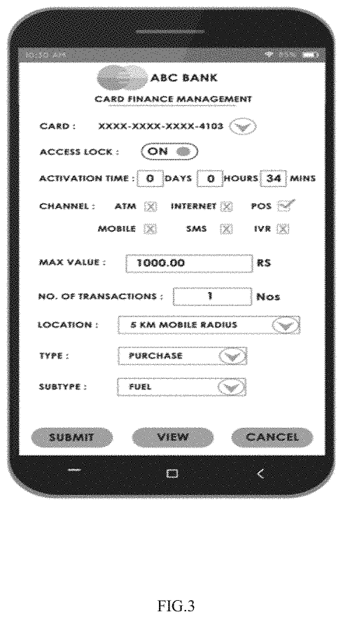

FIG. 2 is a schematic representation of an embodiment representing the system to access the user access channel on occurrence of the financial transaction fraud of FIG. 1 in accordance of an embodiment of the present disclosure. Here, a user X 100 is a customer of a bank Y 90. The user X 100 registers with the bank Y 90 for financial transaction circumstances during financial fraud condition by registering certain details (as shown in FIG. 3). Here, registration happens through registration module 40.

In an exemplary embodiment, the user X 100 experiences a bank fraud, in which the user X 100 Automated Teller Machine ATM card gets stolen. With immediate effect the bank Y 90 blocks the user X 100 account, after user X 100 informs the bank Y 90. The account is blocked by the bank Y 90 for proper security to the assets of the user X 100,

In one exemplary embodiment, the user X 100 may access his account for money, after also the bank account is blocked. In such exemplary embodiment, the hank y 90 follows the criterions as provided during registration. The retrieved information of criterions is enabled by retrieving module 50, Here, a transaction module 60 enables transaction capabilities to the user X 100 after the account is blocked. The predetermined access channel as provided by user X 100 is used for transaction.

In such exemplary embodiment, the user X 100 may before-hand during registration provide information like net banking is to be used when bank fraud condition is detected. And the limit of transaction is rupees twenty thousand. Similarly, such condition is to be followed by the transaction module 60 and a. processing module 70.

Moreover, during transaction, a processing module 70 modifies default state of account. Here, the default state of “blocked” may be changed to “unblocked”. At last, the user X 100 and the bank Y 90 will be notified with the successful transaction by a notification module 80. In one exemplary embodiment, a predetermined time delay may be fixed by the user X 100, so as to provide more security to the transaction after bank fraud.

The registration module 40, the retrieving module 50, the transaction module 60, the processing module 70 and the notifying module 80 in FIG. 2 is substantially equivalent to the registration moduie40, the retrieving module 50, the transaction module 60, the processing module 70 and the notifying module 80 of FIG. 1.

FIG. 3 is a schematic representation of an embodiment representing the system to access the user access channel on occurrence of the financial transaction fraud of FIG. 1 in accordance of an embodiment of the present disclosure. In one exemplary embodiment, the registration module 40 is configured to retrieve information of a user along retrieving module 50. The plurality of criterion retrieved comprises of at least one of access channel state, transaction amount, transaction volume, transaction velocity, permitted location, channel control, transaction type and transaction time.

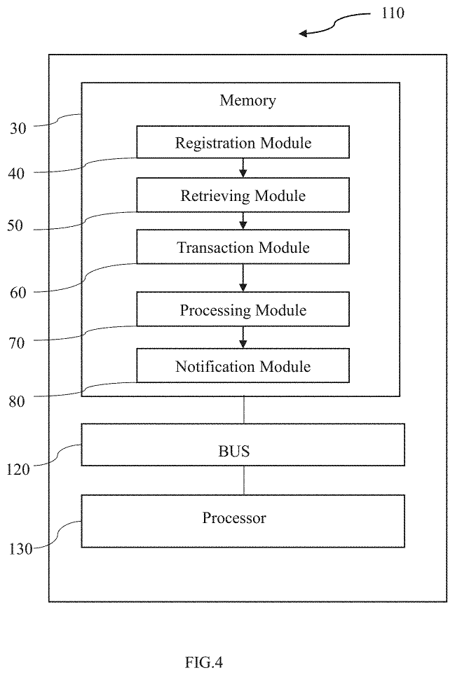

FIG. 4 is a block diagram of a computer or a server 110 in accordance with an embodiment of the present disclosure. The server 110 includes processor(s) 130, and memory 30 coupled to the processor(s) 130.

The processor(s) 130, as used herein, means any type of computational circuit, such as, but not limited to, a. microprocessor, a microcontroller, a complex instruction set computing microprocessor, a reduced instruction set computing microprocessor, a very long instruction word microprocessor, an explicitly parallel instruction computing microprocessor, a access signal processor, or any other type of processing circuit, or a combination thereof.

The memory 30 includes a plurality of modules stored in the form of executable program which instructs the processor 130 to perform the method steps illustrated in FIG. 1. The memory 30 has following modules: the registration module 40, the retrieving module 50, the transaction module 60, the processing module 70 and the notifying module 80. The registration module 40 is configured to register a user of a financial transaction system for accessing an allocated access channel. The retrieving module 50 is configured to retrieve a plurality of criterion from the registered user to enable the allocated access channel. The transaction module 60 is configured to validate authorization and authentication of the registered user and transaction request with respect to the allocated access channel. The processing module 70 is configured to modify a default state of the allocated access channel based on the validation of the plurality of criterion from the registered user. The notification module 80 is configured to notify the registered user about the modified state of the allocated access channel.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 130.

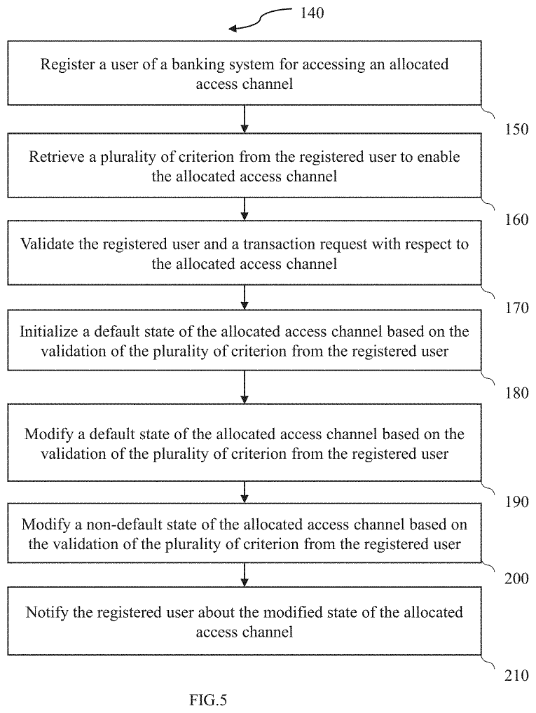

FIG. 5 is a flowchart representing the steps of a method for accessing a channel on occurrence of a BFSI transaction fraud 140 in accordance with an embodiment of the present disclosure.

The method 140 includes registering a user of a financial transaction system for accessing an allocated access channel in a step 150. In one embodiment, registering the user of the financial transaction system for accessing the allocated access channel includes registering the user of the financial transaction system for accessing the allocated access channel by a registration module.

In another embodiment, registering the user of the financial transaction system for accessing the allocated access channel includes registering the user of the financial transaction system for accessing the allocated access channel comprising of at least one of a credit card, a debit card, an Automated Teller Machine (ATM) card, an Internet banking, a Virtual card, a gift card, card tokenization banking, SMS Banking, IVR Banking and a mobile banking.

The method 140 also includes retrieving a plurality of criterion from the registered user to enable the allocated access channel in the step 160. In one embodiment, includes retrieving the plurality of criterion from the registered user to enable the allocated access channel includes retrieving the plurality of criterion from the registered user to enable the allocated access channel by a retrieving module.

The method 140 also includes validating the registered user and a. transaction request with respect to the allocated access channel in the step 170. In one embodiment, validating the registered user and the transaction request with respect to the allocated access channel includes validating the registered user and the transaction request with respect to the allocated access channel by a transaction module.

The method 140 also includes innitializing a default state of the allocated access channel based on the validation of the plurality of criterion from the registered user in the step 180. In one embodiment, innitializing the default state of the allocated access channel based on the validation of the plurality of criterion from the registered use includes innitializing the default state of the allocated access channel based on the validation of the plurality of criterion from the registered use by a processing module.

The method 140 also includes modifying a default state of the allocated access channel based on the validation of the plurality of criterion from the registered user in the step 190. In one embodiment, modifying the default state of the allocated access channel based on the validation of the plurality of criterion from the registered use includes modifying to default state allocated access channel based on the validation of the plurality of criterion from the registered use by the processing module.

The method 140 also includes modifying a non-default state of the allocated access channel based on the validation of the plurality of criterion from the registered user in the step 200. In one embodiment, modifying the non-default state of the allocated access channel based on the validation of the plurality of criterion from the registered use includes modifying the non-default state allocated access channel based on the validation of the plurality of criterion from the registered use by the processing module.

The method 140 also includes notifying the registered user about the modified state of the allocated access channel in the step 210. In one embodiment, notifying the registered user about the modified state of the allocated access channel includes notifying the registered user about the modified state of the allocated access channel by a notification module.

The method 140 also further includes delaying of the validating of the registered user and the transaction request for a predefined time interval with respect to the allocated access channel. In one embodiment, delaying of the validating of the registered user and the transaction request for a predefined time interval with respect to the allocated access channel includes delaying of the validating of the registered user and the transaction request for a predefined time interval by a delaying module.

The method 140 also further includes storing the plurality of criterion from the user corresponding to the allocated access channel. In one embodiment, storing the plurality of criterion from the user corresponding to the allocated access channel includes storing the plurality of criterion from the user corresponding to the allocated access channel by a memory subsystem.

Present disclosure of a system to access a user access channel on occurrence of a financial transaction fraud provides a quick path for transaction of money/monitory value. Here, after financial fraud happens, important factors are taken into consideration before money is made available to the user. Important factors are channel state, Transaction amount, transaction velocity, permitted. location, channel control, type of transaction and combination thereof. Moreover, a time delay mechanism is also incorporated in the present disclosure for providing more security and level of authentication check.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system to access a user access channel on occurrence of a financial transaction fraud, comprising:
a processing subsystem, comprising:
a registration module configured to register a user of a financial transaction system for accessing an allocated access channel;
a retrieving module operatively coupled to the registration module, and configured to retrieve a plurality of criterion from the registered user to enable the allocated access channel;
a transaction module operatively coupled to the retrieving module, and configured to validate authorization and authentication of the registered user and transaction request with respect to the allocated access channel;
a processing module operatively coupled to the transaction module, wherein the processing module is configured to
initialize a default state of the allocated access channel based on the validation of the plurality of criterion from the registered user;
modify a default state of the allocated access
channel based on the validation of the plurality of criterion from the registered user;
a notification module operatively coupled to the processing module, and configured to notify the registered user about the modified state of the allocated access channel; and
a memory subsystem operatively coupled to processing subsystem, and configured to store the plurality of criterion from the user corresponding to the allocated access channel.

2. The system as claimed in claim 1, wherein the allocated access channel comprises of at least one of a credit card, a debit card, virtual card, gift card, coupes based card, an Automated Teller Machine (ATM) card, an internet banking a mobile banking, a SMS banking or an IVR banking.

3. The system as claimed in claim 1, wherein the plurality of criterion comprises of at least one of access channel state, transaction amount, transaction volume, transaction velocity, permitted location, channel control, transaction type and transaction time.

4. The system as claimed in claim it, wherein the modification of the default state comprises of a first state or a second state.

4. A method to access a user access channel on occurrence of a financial transaction fraud, comprising:
registering, by a registration module, a user of a banking system for accessing an allocated access channel;
retrieving, by an retrieving module, a plurality of criterion from the registered user to enable the allocated access channel;
validating, by a transaction module, the registered user and a transaction request with respect to the allocated access channel;
initializing, by a processing module, a default state of the allocated access channel based on the validation of the plurality of criterion from the registered user;
modifying, by the processing module, a default state of the allocated access channel based on the validation of the plurality of criterion from the registered user;
modifying, by the processing module, a non-default state of the allocated access channel based on the validation of the plurality of criterion from the registered user; and
notifying, by a notification module, the registered user about the modified state of the allocated access channel;

6. The method as claimed in claim 5, wherein registering, by a registration module, the user of the financial system for accessing the allocated access channel comprising of at least one of a credit card, a debit card, pre-paid card, gift card, virtual card, tokanization of card, an Automated Teller Machine (ATM) card, an internet banking, a mobile banking, a SMS banking and IVR banking.

7. The method as claimed in claim 5, wherein retrieving, by an retrieving module, the plurality of criterion comprising of at least one of access channel state, transaction amount, transaction volume, transaction velocity, permitted location, channel control, transaction type and transaction time.

8. The method as claimed in claim 5, further comprising delaying, by a delay module, of the validating of the registered user and the transaction request for a predefined time interval with respect to the allocated access channel.

9. The method as claimed in claim 5, further comprising storing, by a memory subsystem, the plurality of criterion from the user corresponding to the allocated access channel.
